(19) United States
(12) Patent Application Publication
(10) Pub. No.: US 2019/0324832 A1
(43) Pub. Date: Oct. 24, 2019

(54) METRIC FOR THE ASSESSMENT OF DISTRIBUTED HIGH-AVAILABILITY ARCHITECTURES USING SURVIVABILITY MODELING

(71) Applicant: Alberto Avritzer, Plainsboro, NJ (US)

(72) Inventor: Alberto Avritzer, Plainsboro, NJ (US)

(21) Appl. No.: 15/956,181

(22) Filed: Apr. 18, 2018

(51) Int. Cl. G06F 11/07

(52) U.S. Cl. CPC G06F 11/079; G06Q 40/12; G06F 11/0793; G06F 11/0754

(57) ABSTRACT

Transient survivability metrics are used to select improvements to distributed computer architecture designs. The approach combines survivability analysis and software aging and rejuvenation analysis to assess the survivability of the distributed computer architecture network. Available investment decisions are then automatically optimized with respect to survivability and investment costs.

### BACKGROUND OF THE INVENTION

### 1. Technical Field

The present invention relates to the assessment of distributed high-availability architectures, and, specifically to the definition and evaluation of a metric for assessing the survivability of such high-availability architectures after a failure. In addition, the invention further relates to approaches for using the survivability metric for optimizing improvements to a high-availability architecture.

### 2. Discussion of the Related Art

High-Availability (HA) is a feature in a computer system to automatically restore computing service after software or hardware failure events.

The survivability of a computer system is the ability of the system to continue functioning during and after a failure or disturbance.

The deterministic state testing approach relied on the Markovian property, or memoryless assumption: all information required to assess behavior in a Markovian state depends only on the state description and not on the path taken to reach the state. Therefore, if a system can be accurately modeled as a Markov chain, the system can be effectively tested by deterministically driving the system to each of the states of interest in the Markov chain and assessing pass/fail criteria for each state.

### SUMMARY OF THE INVENTION

In an exemplary embodiment of the present invention, there is provided a method for selecting features for high-availability architecture improvements to an original high-availability computer system architecture. The original distributed system architecture design identifying as a current system architecture grid. By a processor, a parameterized phased-recovery survivability model of the current system architecture is created by performing a survivability modeling and analysis using a time series of performance loss values of each of a plurality of sections in the computer architecture grid, at each of a plurality of software or hardware failures. An expected performance loss metric of the current architecture grid is determined using the parameterized phased-recovery survivability model of the current architecture grid.

A computer system architecture grid containing a modification to the current computer system architecture grid is generated. A parameterized phased-recovery survivability model of the candidate computer system architecture is created by performing a survivability analysis using a time series of performance loss values of each of a plurality of sections in the computer architecture grid at each of a plurality of software and hardware failures. An expected performance loss metric of the candidate computer system architecture grid is determined, using the phased-recovery survivability model of the candidate computer system architecture grid. Only if the expected performance loss metric of the candidate computer system architecture grid is better than the expected performance loss metric of the current computer system architecture grid, the candidate computer system architecture grid is substituted as the current computer system architecture grid. The operations of this paragraph are repeated until the expected performance loss metric of the current computer system architecture grid meets a survivability requirement for the grid.

The method may further comprise ceasing the repeating of the operations before the survivability requirement for the computer system architecture grid is met when the candidate computer system architecture grid exceeds a budget for improvement costs, or when a maximum number of iterations is reached.

Generating a candidate computer system architecture grid containing a modification to the current computer system architecture grid may further comprise choosing between adding a new architecture feature, e.g., pro-active software aging monitoring and rejuvenation, or adding a new computer system architecture section to the grid.

The operation of a candidate computer system architecture grid containing a modification to the current computer system architecture grid may include selecting new computer architecture features to add to the current computer system architecture grid; and selecting one of the plurality of sections to activate the new computer architecture feature.

As another aspect to this invention, non-transitory computer useable media are provided having computer readable instructions stored thereon for execution by a processor to perform operations as described above.

### BRIEF DESCRIPTION OF THE DRAWINGS

FIG. 1 is a taxonomy of survivability related metrics, according to an exemplary embodiment of the present invention;

FIG. 2 is a schematic diagram of a computer architecture grid used in a case study described herein, where a failed section of the computer architecture grid is shown, according to an exemplary embodiment of the present invention;

FIG. 3 illustrates a phase recovery model according to an exemplary embodiment of the present invention;

FIG. 4 is a flowchart illustrating an exemplary embodiment of the present invention; and

FIG. 5 illustrates a computer system in which an exemplary embodiment of the present invention may be implemented.

FIG. 6 is a flow chart illustrating a method in accordance with one embodiment of the invention.

FIG. 7 illustrates a phase recovery model high-availability path according to an exemplary embodiment of the present invention.

FIG. 8 illustrates a phase recovery model acyclic chain accounting for simplified survivability analysis according to an exemplary embodiment of the present invention.

### DETAILED DESCRIPTION OF EXEMPLARY EMBODIMENTS

In accordance with an exemplary embodiment of the present invention, presented herein is an analytical model to assess the survivability of distributed computer architecture grids. In this exemplary embodiment, a performability model is used to capture how the system recovers from a failure. The model accounts for the fact that the topology is sectionalized. Given a failure in a section, a key insight is to assess the failure impact according to the impact of the section failure on the expected performance loss metric. This aggregation allows transient metrics of the network to be efficiently quantified after a failure, also referred to as survivability metrics. For example, the model allows the computation of how the expected performance loss after a failure varies over time as a function of the number of available computer backup sections, the software aging detection and rejuvenation feature, the state of the NOSQL database and of the communication network.

After a hardware or software failure event, some sections of the computer architecture grid may experience restoration times of the order of magnitude of seconds, while other grid areas may require minutes for failure restoration. In addition, if manual repair events need take place the failure may require hours for restoration. The model allows for the accurate assessment of the computer system architecture survivability by tracking the time-dependent state of the system under study.

Some of the main contributions of this invention are the following.

Survivability model. Presented herein is a Markov chain model that supports the survivability assessment of distributed computer architecture grid metrics accounting for the sectionalizing of the distributed computer architecture, the available computer processing power, the unreliability of the computer network and the interaction with the NOSQL database. The model can be generated and solved in a cost-efficient manner.

Implications of system integration. The invention brings awareness to the importance of accurate holistic distributed computer system architecture that considers the interactions between network reliability and the reliability benefits of integration with other computer architecture features, such as the integration of failure recovery with software aging detection and software rejuvenation. In particular, it is shown that if software aging detecting and software rejuvenation response can be activated before a failure occurs, the reliability of the system significantly increases.

The invention also presents an extension of the high-availability modeling of distributed computer system architectures that captures the dynamic nature of the distributed computer system architectures by taking into account the performance loss impact of the software and hardware failure and the duration of the recovery period. The analytical solution of the survivability model is used to capture the time spent in each state during the recovery period and the reward associated with each state to capture the performance loss impact of the interruption caused by the software or hardware failure.

Survivability metrics that can be derived from the inventive model will now be discussed.

Survivability is the ability of a system to continue to function during and after a disturbance. It has been defined by ANSI as the transient performance of a system after an undesirable event. The metrics used to quantify survivability vary according to applications, and depend on a number of factors such as the minimum level of performance necessary for the system to be considered functional, and the maximum acceptable outage duration of a system. Survivability metrics are transient metrics computed after the occurrence of a failure. In the remainder of this disclosure, time refers to the time since a failure occurred and is measured in seconds.

In an exemplary embodiment of the present invention, survivability metrics are computed with respect to a measure of interest, also referred to as the performance metric. In the realm of distributed computer system architectures, an example of the performance metric of interest could be the throughput, the number of transactions successfully completed per second, measured in transactions per second. Assuming that throughput has a normalized value of 1 just before a software instance or hardware instance failure occurs, the survivability behavior is quantified by attributes such as the relaxation time for the system to restore the normalized throughput value of to 1. In this disclosure, metrics related to the relaxation time are computed, focusing on average throughput after a failure occurs.

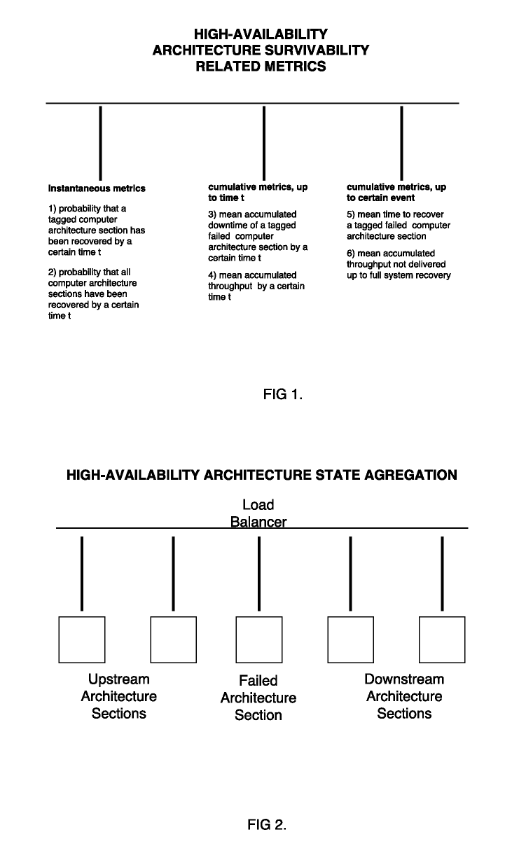

FIG. 1 shows the taxonomy of the survivability related metrics considered in this disclosure. Metrics are classified into two broad categories. Instantaneous metrics are transient metrics that capture the state of the system at time t. An example of an instantaneous metric is the probability that a computer architecture section has been recovered by a certain time.

Cumulative metrics are obtained in the inventive model by assigning reward rates to system states. A reward is gained per time unit in a state, as determined by the reward rate assigned to that state. The accumulated reward is the result of the accumulation of rewards since the computer architecture section, software instance failure, or hardware instance failure, up to a certain time or up to a certain event. The mean accumulated downtime of a given architecture section by a certain time and the mean accumulated throughput not delivered by a certain time are examples of cumulative metrics computed up to a certain time. The mean accumulated throughput not delivered up to the full recovery of the distributed architecture system is an example of a cumulative metric computed up to a certain event occurs. The mean time to recover a given computer architecture section is also an example of the latter class of metrics, where the accumulated reward in this case is the time itself, obtained by assigning a reward of one per time unit at every state.

After a failure, the normalized throughput will vary over time during a multi-step recovery process.

The inventive model used to compute survivability metrics of distributed architecture systems is now presented.

The methodology presented herein relies on these key principles: state space factorization, flexibility, state aggregation and initial state conditioning.

State space factorization. The methodology encompasses a set of models, where each model characterizes the system evolution after the failure of a given system architecture section. Given a computer architecture system topology with sections, the methodology yields models, where each model is tailored to the characteristics of the failed architecture section. The advantages of such a space factorization include flexibility and reduced complexity as described below.

Flexibility: having a model tailored to a given architecture section enables specific details to be captured about the impacts of failures on that particular section.

State aggregation. One of the insights of this disclosure is the observation that after a failure of a given architecture section the remaining sections of the distributed computer architecture topology can be aggregated into groups of affected and non-affected computer architecture sections. The scenario considered in the remainder of this disclosure is shown in FIG. 2. State aggregation yields significant reduction in the computational complexity required to obtain the desired metrics, since the system state space can be described in terms of the aggregated section states.

Initial state conditioning. The computations of the metrics of interest are performed by assuming that the initial state is a failure state. The inventive models do not capture the failure rates of different computer architecture components. Instead, the models are parameterized by using the conditional probability that specific computer architecture components are still operational after a specific computer architecture section failure. In the remainder of this disclosure, conditional probabilities will be considered to account for the probability that a backup computer architecture section can provide primary service, the reliability of the computer network, and the effectiveness of the computer architecture software aging and rejuvenation feature.

An overview of the inventive model is now provided.

Automatic and manual restoration events are initiated after a computer architecture section failure event. The restoration process is a combination of operator-based and computer-based events. In what follows, the sequence of events initiated after the failure of a computer architecture section is described.

By a processor, the isolation of the failed computer section is automatically performed by automated failure detection at the high-availability computer architecture component, at the load balancer or at NOSQL database computer section, within several seconds after the failure is detected, and service is instantaneously restored to the downstream computer architecture system sections. The upstream sections, which are isolated from the primary computer architecture section have their service restored depending on the following factors: network partitioning restoration, backup computer section service availability and software rejuvenation based restoration.

Network communication. Network communication is needed for normal operation and for distributed computer system failure detection, isolation and recovery operations.

Backup computer service availability. Sufficient spare computer processing power must be available at the backup computer architecture sections to restore service to users that had been served by the computer sections that are not accessible throughout a network partitioning event.

Software rejuvenation based restoration. Software aging detection and software rejuvenation can be used to pro-actively detect a prone to aging software state before failure occurs to effectively reduce software recovery time.

TABLE I
Survivability Model Parameterization
(Value is given in seconds)

| | Description (Times obtained from | Value |
|---|---|---|
| Parameter | controlled experiments) | (seconds) |
| dt | Mean time for detection of the failed | 60 |
| | architecture component section | |
| δ₀⁻¹ | Software patching or configuration | 14400 |
| δ₁⁻¹ | System process reboot | 60 + dt |
| δ₂⁻¹ | Failover to computer architecture | 420 + dt |
| | section on same host | |
| δ₃⁻¹ | Failover to computer architecture | 60 |
| | section on different host | |
| μ_{nb}⁻¹ | Restore network and NOSQL database | 300 + dt |
| μₕ⁻¹ | Manually Repair failed host | 121 + dt |
| μ_{b}⁻¹ | Restore NOSQL database | 60 + dt |
| φ⁻¹ | Repair partial failure (aging and | 256 + dt |
| | non-aging) | |
| ρ⁻¹ | Monitoring times for software aging | 1 |
| τ⁻¹ | Software rejuvenation time | 45 |
| pₛᵣ | Probability of software rejuvenation | 1 |
| | success | |
| p₀ | Probability of software failure | 0.457 |
| | requiring patch or change in | |
| | configuration | |
| p_{b} | Failure probability for NOSQL database | ⅓ |
| p_{nb} | Failure probability for Network and | ⅓ |
| | NOSQL database | |

After a computer architecture component section failure, Table 1 shows the different recovery times required for failure recovery, depending on the recovery path taken from failure to recovery. Detection time is assumed to take 60 seconds. If a software patch or a reconfiguration is required the average recovery time will be 14400 seconds. If recovery will be implemented using a system process reboot, recovery time will take an average of 60 seconds. Failover to a computer architecture component on the same host will take an average of 420 seconds. Failover to a computer architecture component on the different host will take an average of 60 seconds, as it will be automatically implemented by the load balancer. These failover methods can be implemented, if network and NOSQL database are still operational during failure recovery. Otherwise, network and NOSQL database recovery will take 300 seconds. Restoring a failed NOSQL database will require 60 seconds.

A failed host may require manual repair. Manual repair of a failed host takes an average of 121 seconds. Monitoring for software aging may be used to detect prone to aging software state. Software aging and detection feature is used for software aging monitoring at a rate of 1 monitoring event per second. When software aging is detected, the system transitions into a software rejuvenation state. Software rejuvenation recovery takes 45 seconds. In addition, a partial failure due to aging repair will take 256 seconds. A partial failure not due to aging will take 256 seconds for repair.

A description of the inventive model is now provided.

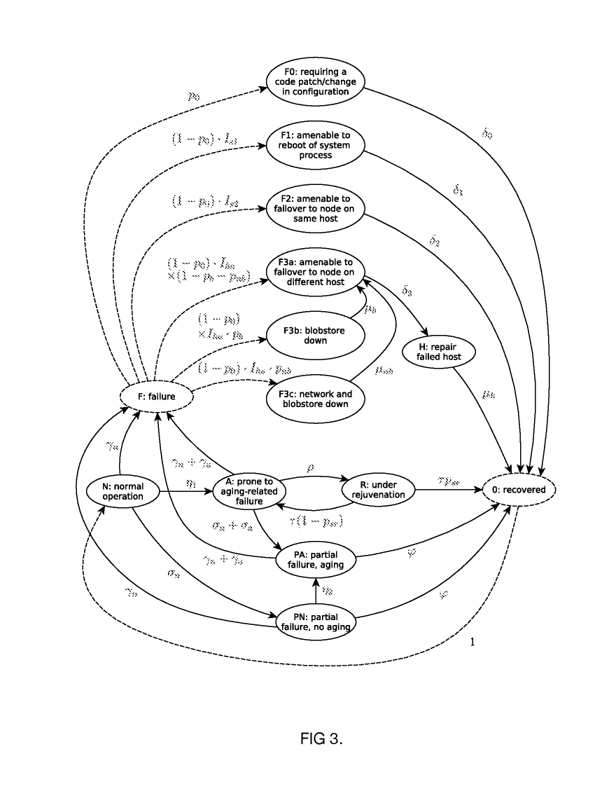

A Markov chain with rewards is used to model the phase recovery of the of the computer architecture component section failure. The states of the model correspond to the different recovery phases at which the system might be found as shown in FIG. 3. Each state is associated with a reward rate that corresponds, for instance, to the number of transaction per second not successfully completed in that state. In this disclosure, it is assumed that state residence times are exponentially distributed, which serves to illustrate the inventive methodology in a simple setting. The model may be extended to allow for general distributions for the state residence times. The system states and the state rewards are described in the following.

Phase recovery model. The phase recovery model is characterized by the following states and events.

As shown in FIG. 3, after a computer architecture component section failure, the model is initialized in state F. The residence time at state F corresponds to the time required for computer architecture monitoring component to isolate the failure and select the computer architecture recovery method to be employed. This time is assumed to be in milliseconds, and therefore in FIG. 3. we show the transition probability to each of the recovery states. The failure detect time is incorporated into the recovery state as shown in Table 1. After the determination of the failure recovery method to be employed the model transitions to one of six states:

1) With probability p₀, the model transitions to state F0, where the computer architecture section requires a code or patch/change in the system configuration, which occurs at rate δ₀, or

2) With probability (1−p₀)·I_{S1}, the model transitions to state F1, where the computer architecture section is amenable to reboot of process, which occurs at rate δ₁, or

3) With probability (1−p₀)·I_{S2}, the model transitions to state F2, where the computer architecture section is amenable to failover to a node on the same host, which occurs at rate δ₂, or

4) With probability (1−p₀)·Iₕₐ·(1−p_{b}−_{nb}), the model transitions to state F3a, where the computer architecture section is amenable to failover to a node on a different host, which occurs at rate δ₃, or

5) With probability (1−p₀)·Iₕₐ·p_{b}, the model transitions to state F3b, where the the NOSQL database is down. NOSQL database recovery occurs at rate μ_{b}, or

6) With probability (1−p₀)·Iₕₐ·p_{nb}, the model transitions to state F3 c, where the the communication network and the NOSQL database are down. NOSQL database and network recovery occurs at rate μ_{rib}.

At state A, the computer architecture section is prone to a aging related failure.

At state R software rejuvenation takes place after a period of time with average duration τ. Let pₛᵣ be the probability of successful software rejuvenation. In this case, the model transitions from state R to state 0 with rate τ·pₛᵣ.

When the model is in states F2 or F3a the computer architecture section is amenable to failover, which occurs after a period of time with average duration of δ₂ and δ₃. What distinguishes state F2 from state F3a is the fact that in state F2 the computer architecture section failover occurs at the same host, reaching state 0 in one step, whereas in state F3a state 0 is reached only after the successful manual repair of the failed host. Therefore, from state F3a an intermediate state H is reached after the failover to a different host. In addition, in state H a repair of the failed host is required, which occurs at rate μₕ. Therefore, the state reward rates associated to states F2 and F3a, such as the expected performance loss (e.g. transaction/sec) at those states, are usually different. A manual repair of the failed host may vary from minutes to hours. After the manual repair of the failed host, the model transitions to state 0, which corresponds to a fully repaired computer architecture system.

The computation of the survivability metric (e.g., mean accumulated throughput not delivered up to the full recovery of the distributed architecture system) will now be described by using the phase recovery model described in FIG. 3. In each state of the model of FIG. 3 the throughput not supplied per second at that state is associated as the state reward. Let be the transient probability associated with state i be πᵢ(t) and let be the reward rate (e.g., mean throughput not supplied per second) associated with state i be ηᵢ. Let Γ(t) be a random variable characterizing the reward accumulated time after a failure by time t (e.g., accumulated throughput not supplied by time t). The mean reward accumulated by time t is Γ(t)=Σᵢ∫_{y=0}^{y=t}nᵢπᵢ(y)dy.

Let sᵢ be the residence time spent in state i before reaching state 0 (i.e., up to full system recovery). The mean reward accumulated up to full system recovery is Σᵢnᵢsᵢ

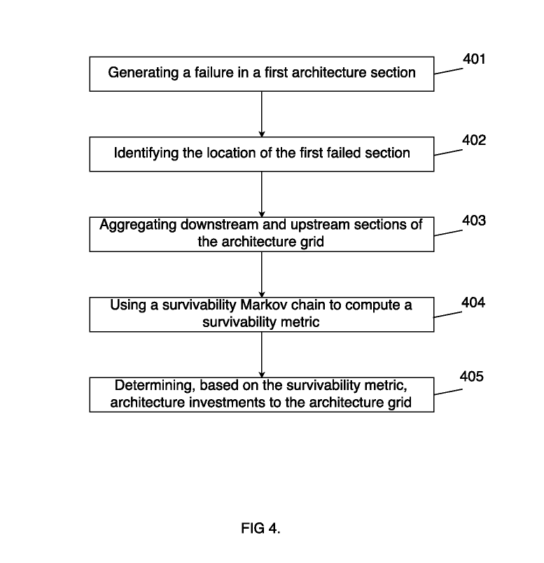

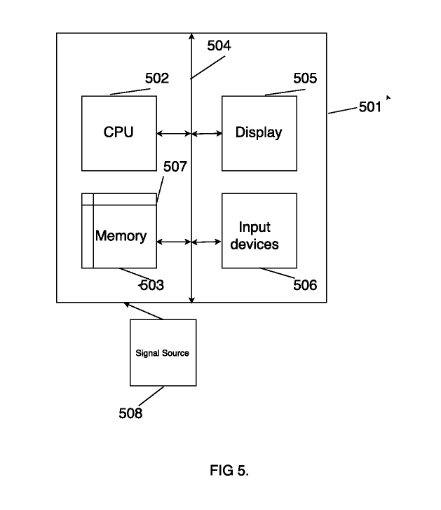

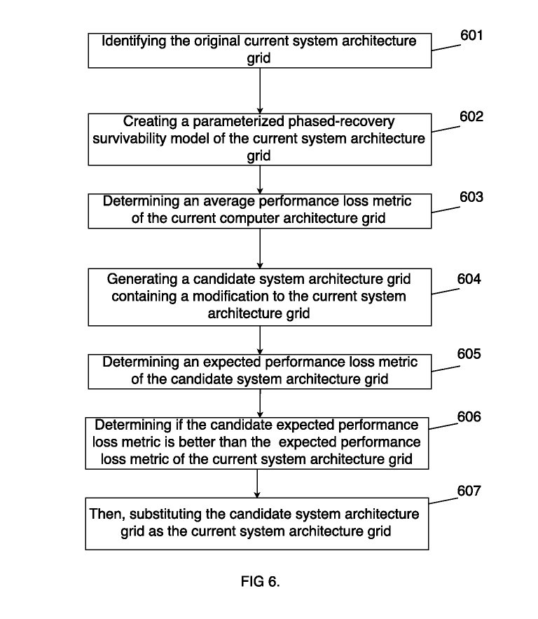

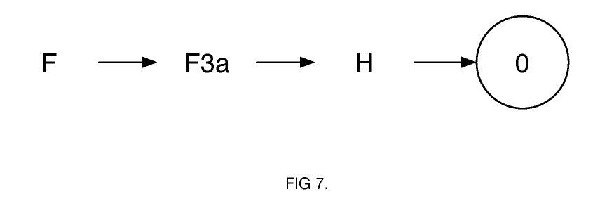

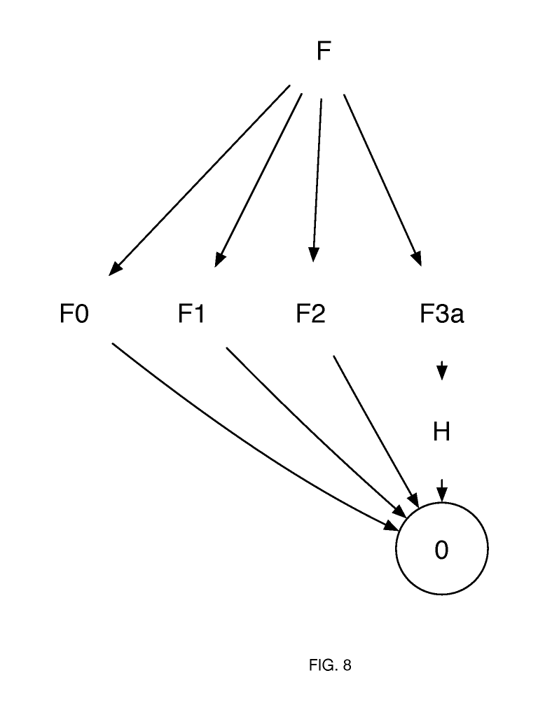

FIG. 4 is a flowchart illustrating an exemplary embodiment of the present invention. Steps 401, 402 and 403 are related to the software failure events impacting the state of the distributed computer architecture system. As shown in FIG. 4, in step 401, a failure may be generated in a generic section of a distributed computer architecture system. As an example, computer architecture section failures are usually caused by software issues related to concurrency or performance events (e.g., NOSQL database deadlocks, memory leaks, software concurrency issues, etc).

The failure may be in a generic section in FIG. 2. In step 402, the location of the software failure in the computer architecture section may be identified and isolated.

Step 404 is a modeling step used to compute the survivability metric. In step 405, architecture investments based on the survivability metric may be determined.

In this invention, introduced is a new approach for the evaluation of the likelihood distributed high-availability computer architecture survivability. In the above, we described the modeling approach to assess this metric. The approach consists of creating a survivability test suite and applying Markov modeling to the assessment of the distributed high-availability computer architecture survivability after the occurrence of a software or hardware computer system failure. The survivability test suite uses as input the list of the most likely failures and distributed high-availability computer architecture configurations. The output of the survivability testing phase is a metric that captures the required time for the distributed high-availability computer architecture to return to correct operation after a software or hardware failure. The distribution automation survivability metric is computed using the introduced high-availability Markov chain.

An exemplary function of this invention is to provide a tool to be used by distributed high-availability computer architects and software engineers to assess the time required to recover from software and hardware failures. Software engineers can use this tool to assess the reliability and survivability benefits of investing in the infrastructure for survivability. In addition, because the approach can be automatically parameterized and executed, computer architects and software engineers can also use the approach to dynamically track the survivability of their distributed high-availability computer architectures.

More specifically, by using this invention distributed high-availability computer architecture and software engineers will be able to automatically assess the investment tradeoffs involved in designing distributed high-availability computer architectures. Software engineers will be able to use the transient modeling approach to assess distributed high-availability computer architectures survivability after the occurrence of certain types of software and hardware failures. Software engineers will also be able to stochastically compute, using the survivability based test case configurations, the survivability of distributed high-availability computer architectures.

The inventive method to assess the distributed high-availability computer architecture survivability condition on the occurrence of a software or hardware failure shows superior performance because it has improved accuracy and efficiency.

As it pertains to accuracy, the test cases used for the evaluation of the survivability metric require detailed monitoring of the system architecture resource software and hardware failures. The system grid survivability metric conditioned on the occurrence of software and hardware failures security shall be re-evaluated to detect changes in the available computer architecture resources.

As it pertains to efficiency, the derivation of a workload demand test suite based on known system architecture resource demands and software and hardware failures is an important advantage, as it allows the system architect to focus on a significantly shorter list of likely software and hardware failures. When new workload demand types are introduced in the computer architecture grid, the system architecture workload demand test suite may be updated to account for the impact of these new demand types on the computer architecture survivability.

The invention could also be generalized to automatically evaluate the required computer system architecture resources investment when the system survivability metric conditioned on software and hardware failures, crosses a pre-defined threshold. This generalization could require that this invention be applied to detect workload demand and available system architecture backup capacity to detect load balancing opportunities and system architecture capacity shortages using online monitoring.

The inventive approach may be extended to incorporate software aging detection and software rejuvenation approaches into the survivability model introduced in this invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radio frequency (RF), etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article or manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Referring now to FIG. 5, according to an exemplary embodiment of the present invention, a computer system 501 can comprise, inter alia, a central processing unit (CPU) 502, a memory 503 and an input/output (I/O) interface 504. The computer system 501 is generally coupled through the I/O interface 504 to a display 505 and various input devices 506 such as a mouse and keyboard. The support circuits can include circuits such as cache, power supplies, clock circuits, and a communications bus. The memory 503 can include RAM, ROM, disk drive, tape drive, etc., or a combination thereof. Exemplary embodiments of present invention may be implemented as a routine 507 stored in memory 503 (e.g., a non-transitory computer-readable storage medium) and executed by the CPU 502 to process the signal from a signal source 508. As such, the computer system 501 is a general-purpose computer system that becomes a specific purpose computer system when executing the routine 507 of the present invention.

The computer system 501 also includes an operating system and micro-instruction code. The various processes and functions described herein may either be part of the micro-instruction code or part of the application program (or a combination thereof) which is executed via the operating system. In addition, various other peripheral devices may be connected to the computer system 501 such as an additional data storage device and a printing device.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described to best explain the principles of the invention and the practical application, and to enable others of ordinary skill in the art to understand the invention for various embodiments with various modifications as are suited to the particular use contemplated.

This disclosure includes explanatory materials from the following paper: Alberto Avritzer, Daniel Sadoc Menache, Michael Grottke, “Empirical Survivability Assessment of High-Availability Systems Using Markov Chains” submitted for publication Handbook of Software Aging and Rejuvenation, to appear, September 2018. Included as an attachment.

What is claimed is:

1. A method for selecting improvements to an original high-availability computer system architecture, the method comprising:
(a) identifying the original current system architecture grid;
(b) by the processor, creating a parameterized phased-recovery survivability model of the current system architecture by performing a survivability modeling and analysis using a time series of performance loss values of each of a plurality of components in the computer architecture grid, at each of a plurality of software or hardware failures;
(c) by the processor, determining an average performance loss metric of the current computer architecture grid, using the parameterized phased-recovery survivability model of the current system architecture grid;
(d) generating a candidate system architecture grid containing a modification to the current system architecture grid;
(e) by the processor, determining an expected performance loss metric of the candidate system architecture grid using the phased-recovery survivability model of the candidate system architecture grid;
(f) only if the expected performance loss metric of the candidate system architecture grid is better than the expected performance loss metric of the current system architecture grid, substituting the candidate system architecture grid as the current system architecture grid;
(g) repeating the operations (c) (d), (e), (f) and (g) until the expected performance loss metric of the current system architecture grid meets a survivability requirement for the system architecture grid.

2. A method as in claim 1, further comprising:
ceasing the repeating of operations (c) (d), (e), (f) and (g) before the survivability requirement for the system architecture grid is met when the candidate system architecture grid exceeds a budget for improvement costs.

3. A method as in claim 1, further comprising:
ceasing the repeating of operations (c) (d), (e), (f) and (g) before the survivability requirement for the system architecture grid is met when a maximum number of iterations is reached.

4. A method as in claim 1, wherein creating a parameterized phased-recovery survivability model of the current system architecture further comprises:
computing violation of performance or survivability requirements, wherein each element of the violation indicates whether one of the plurality of computer architecture components violates performance or survivability requirements at one of the plurality of software or hardware failure events.

5. A method as in claim 4, wherein generating a candidate system architecture containing a modification to the current system architecture further comprises:
choosing between adding pro-active software aging detection and software rejuvenation source based on an evaluation of a number of performance or survivability requirements violations at one of the plurality of software or hardware failure events.

6. A method as in claim 1, wherein generating a candidate system architecture grid containing a modification to the current system architecture grid further comprises:
selecting a modification using a greedy algorithm designed to choose a most efficient computer architecture component having a greatest CPU speed per unit cost.

7. A method as in claim 1, wherein generating a candidate system architecture grid containing a modification to the current system architecture further comprises:
selecting a modification using a greedy algorithm designed to choose a lowest CPU cost.

8. A method as in claim 1, wherein generating a candidate system architecture containing a modification to the current system architecture further comprises:
selecting a modification using a greedy algorithm designed to choose a most powerful computer architecture components in terms of provided CPU speed.

9. A method as in claim 1, wherein generating a candidate system architecture containing a modification to the current system architecture further comprises:
selecting a modification using a steepest-ascent greedy algorithm designed to maximize improvement based on greatest provided CPU speed, lowest cost and greatest efficiency.

10. A method as in claim 1, wherein generating a candidate system architecture containing a modification to the current system architecture further comprises:
selecting equipment to add to the current system architecture, such as memory or NOSQL database bandwidth; and
selecting one of the plurality of computer architecture sections wherein to place the equipment.

11. A non-transitory computer-usable medium having computer readable instructions stored thereon that, when executed by a processor, cause the processor to perform operations for selecting improvements to an original system architecture, the operations comprising:
(a) identifying the original system architecture grid design as a current system architecture;
(b) creating a parameterized phased-recovery survivability model of the system architecture by performing survivability modeling using a time series of expected workload values of each of a plurality of sections in the system architecture grid at each of a plurality of software or hardware failures;
(c) determining an expected performance loss metric of the current system architecture, using the parameterized phased-recovery survivability model of the current system architecture;
(d) generating a candidate system architecture containing a modification to the current system architecture;
(e) creating a parameterized phased-recovery survivability model of the candidate system architecture by performing survivability modeling analysis using a time series of workload values of each of a plurality of sections in the system architecture grid at each of a plurality of software or hardware failures;
(f) determining an expected performance loss metric of the candidate system architecture, using the phased-recovery survivability model of the candidate system architecture;
(g) only if the expected performance loss metric of the candidate system architecture is better than the expected performance loss metric of the current system architecture, substituting the candidate system architecture as the current system architecture;
(h) repeating the operations (d), (e), (f) and (g) until the expected performance loss metric of the current system architecture meets a survivability requirement for the grid.

12. A non-transitory computer-usable medium as in claim 11, wherein the operations further comprise:
ceasing the repeating of operations (d), (e), (f) and (g) before the survivability requirement for the system architecture grid is met when the candidate system architecture exceeds a budget for improvement costs.

13. A non-transitory computer-usable medium as in claim 11, wherein the operations further comprise:
ceasing the repeating of operations (d), (e), (f) and (g) before the survivability requirement for the system architecture grid is met when a maximum number of iterations is reached.

14. A non-transitory computer-usable medium as in claim 11, wherein creating a parameterized phased-recovery survivability model of the current system architecture further comprises:
computing violation matrices reflective of violations of performance and survivability requirements, wherein each element of the violation indicates whether one of the plurality of sections violates performance and survivability requirements at one of the plurality of software and hardware failures.

15. A non-transitory computer-usable medium as in claim 11, wherein generating a candidate system architecture containing a modification to the current system architecture further comprises:
choosing between adding an software aging detection and software rejuvenation feature based on an evaluation of a number of performance and survivability violations.

16. A non-transitory computer-usable medium as in claim 11, wherein generating a candidate system architecture containing a modification to the current system architecture further comprises:
selecting a modification using a greedy algorithm designed to choose a most efficient CPU component having a greatest CPU speed per unit cost.

17. A non-transitory computer-usable medium as in claim 11, wherein generating a candidate system architecture containing a modification to the current system architecture further comprises:
selecting a modification using a greedy algorithm designed to choose a lowest CPU cost.

18. A non-transitory computer-usable medium as in claim 11, wherein generating a candidate system architecture containing a modification to the current system architecture further comprises:
selecting a modification using a greedy algorithm designed to choose a most powerful computer architecture components in terms of provided CPU speed.

19. A non-transitory computer-usable medium as in claim 11, wherein generating a candidate system architecture containing a modification to the current system architecture further comprises:
selecting a modification using a steepest-ascent greedy algorithm designed to maximize improvement based on greatest provided CPU speed, lowest cost and greatest efficiency.

20. A non-transitory computer-usable medium as in claim 11, wherein generating a candidate system architecture containing a modification to the current system architecture further comprises:
selecting equipment to add to the current system architecture, such as memory or NOSQL database bandwidth; and
selecting one of the plurality of computer architecture sections wherein to place the equipment.
